(19) United States
(12) Patent Application Publication
(10) Pub. No.: US 2005/0174294 A1
(43) Pub. Date: Aug. 11, 2005

(54) Switchable slot antenna

(75) Inventors: Dimitrios Peroulis, Ann Arbor, MI (US); Kamal Sarabandi, Ann Arbor, MI (US); Linda P. Katehi, Pass Zionsville, IN (US)

Correspondence Address: YOUNG & BASILE, P.C., 3001 WEST BIG BEAVER ROAD, SUITE 624, TROY, MI, 48084, US

(73) Assignee: The Regents of the University of Michigan, Ann Arbor, MI (US)

(21) Appl. No.: 10/515,132

(22) PCT Filed: May 31, 2002
(86) PCT No.: PCT/US02/17371

(51) Int. Cl. H01Q 13/10

(52) U.S. Cl. 343/746

(57) ABSTRACT

A compact, efficient and electronically tunable antenna is presented. A single-fed resonant slot loaded with a series of PIN diode switches constitute the fundamental structure of the antenna. The antenna tuning is real by changing its effective electrical length, which is controlled by the bias voltages of the solid state shunt switches along the slot antenna. Although the design is based on a resonant configuration, an effective bandwidth of 1.7:1 is obtained through this tuning without requiring a reconfigurable matching network. Four resonant frequencies from 540 to 890 MHz are selected in this bandwidth and very good matching is achieved for all resonant frequencies. Theoretical and experimental behavior of the antenna parameters is presented and it is demonstrated that the radiation pattern, efficiency and polarization state of the antenna remain essentially unaffected by the frequency tuning.

### FIELD OF THE INVENTION

The present invention relates to a reconfigurable slot antenna having a plurality of shunt switches for changing an electrical length of the slot.

### BACKGROUND OF THE INVENTION

With ever-increasing demand for reliable wireless communications, the need for efficient use of electromagnetic spectrum is on the rise. In modern wireless systems spread spectrum signals are used to suppress the harmful effects of the interference from other users who share the same channel (bandwidth) in a multiple-access communication system and the self-interference due to multipath propagation. Also spread spectrum signals are used for securing the message in the presence of unintended listeners and alleviating the effects of communication jammers. One common feature of spread spectrum signals is the relatively high bandwidth. This is specifically true for frequency-hopped spread spectrum communications system. In a frequency-hopped spread spectrum system a relatively large number of contiguous frequency slots spread over a relatively wide bandwidth are used to transmit intervals of the information signal. The selection of the frequency slots for each signal interval is according to a pseudo-random pattern known to the receiver.

Signal propagation over large distances and in urban and forested environment can take place at UHF and lower frequencies. At these frequencies, the size of broadband and efficient antennas is considerable. Techniques used to make the antenna size small, usually renders narrow-band antennas. To make miniature size antennas compatible for a frequency-hopped spread spectrum system, we may consider a reconfigurable narrow-band antenna that follows the pseudo-random pattern of the frequency-hopped modulation. The design aspects of compact, planar, and reconfigurable antennas are considered and the feasibility of such designs is demonstrated by constructing and testing a planar reconfigurable slot antenna operating at UHF.

Compared to broadband antennas, reconfigurable antennas offer the following advantages: 1) compact size, 2) similar radiation pattern and gain for all designed frequency bands, and 3) frequency selectivity useful for reducing the adverse effects of co-site interference and jamming.

In recent years, reconfigurable antennas have received significant attention for applications in communications, electronic surveillance and countermeasures by adapting properties to achieve selectivity in frequency, bandwidth, polarization and gain. In particular, preliminary studies have been carried out to demonstrate electronic tunability for different antenna structures. It has been shown that the operating frequency or bandwidth of resonant antennas can be varied when a tuning mechanism is introduced. Several interesting approaches are presented. In the literature, tuning is accomplished using varactor diodes, or by the application of electrically and magnetically tunable substrates, with the use of barium strontium titanate (BST) and ferrite materials respectively.

Tuning of printed dipole or slot antennas has also been considered since they share the same advantages of portability, low profile and compatibility in integration with other monolithic microwave integrated circuits (MMICs). It has been shown in the literature that a 1 λ slot antenna can be tuned if loaded with reactive FET components. Although the radiation pattern properties could be preserved in all resonant frequencies, the tuning range of the resulting antenna was very limited. Second-resonance cross slot antennas have also been presented in a mixer/phase detector system. In this application, a varactor diode was used in the microstrip feed-line and the resonance could be electronically tuned over a 10% bandwidth. This bandwidth was increased to 45% when mechanical tuning was used by varying the feed-line length. Printed dipole tunable antennas have also been demonstrated loaded in series with PIN diodes. The dipole length was varied from λ/2 to 1λ depending on whether the diodes were off or on. The operating frequencies were selected from 5.2 to 5.8 GHz, and only a very limited matching of 4-5 dB was achieved.

### SUMMARY OF THE INVENTION

The slot antenna proposed in the present invention uses shunt switches that effectively change its electrical length over a very wide bandwidth. To demonstrate the technique a reconfigurable slot antenna capable of operating at four different resonant frequencies over a bandwidth of 1.7:1 is designed and tested. Measurements of the return loss indicate that excellent impedance match can be obtained for all selected resonant frequencies. No special matching network is used and the matching properties are solely determined by the placement of the switches. The loading effect of the PIN diodes in the antenna is also characterized by a full wave analysis and transmission line theory and comparisons between the real and ideal switches are also studied. Per design goals, it is demonstrated that the reconfigurable slot antenna has the same radiation pattern at all frequencies. Also, the measured radiation patterns agree with the theoretical ones. The polarization characteristics and the efficiency behavior of the antenna as a function of frequency are investigated using both theoretical and experimental data Finally, some design guidelines are provided and possible design improvements are discussed.

The strict requirements of a constant input impedance, gain, radiation pattern and polarization can only be met, if both the passive structure and the tuning mechanism are carefully designed and effectively integrated into the final design. Therefore, these issues are discussed separately. First, the passive antenna structure and its properties are discussed. The switching mechanism, its loading effect on the antenna and the final reconfigurable antenna are discussed next. Finally, the measured results are presented.

Other applications of the present invention will become apparent to those skilled in the art when the following description of the best mode contemplated for practicing the invention is read in conjunction with the accompanying drawings.

### BRIEF DESCRIPTION OF THE DRAWINGS

The description herein makes reference to the accompanying drawings wherein like reference numerals refer to like parts throughout the several views, and wherein:

FIG. 1 is a resonant length at 600 MHz for straight slot antenna (in free-space wavelength) as a function of substrate thickness and dielectric constant;

FIG. 2A is a computed magnetic current distribution on 600 MHz straight slot antenna;

FIG. 2B is a computed magnetic current distribution on 600 MHz S-shape slot antenna;

FIG. 2C is a computed magnetic current distribution on 700 MHz S-shape slot antenna;

FIG. 2D is a computed magnetic current distribution on 600 MHz S-shape slot with a short-circuit 21 mm above its bottom edge;

FIG. 3A is a S-shape slot antenna with microstrip feed-line;

FIG. 3B is the real and imaginary parts of the input impedance as a function of frequency;

FIG. 4 is simulated results for the return loss of the S-shape slot antennas presented in FIGS. 2A through 2D;

FIG. 5A is a PIN diode connected as a shunt switch in a transmission line;

FIG. 5B is a RF equivalent circuit for PIN diode including packaging effects;

FIG. 5C is the isolation from the shunt diode used as a switch placed in a 60 Ω transmission line;

FIG. 6A is a layout of switch biasing network;

FIG. 6B is a RF equivalent circuit;

FIG. 6C is the On and Off-state simulated RF performance;

FIG. 7A is the RF equivalent circuits for determining the resonant frequency of an unloaded single switch slot antenna;

FIG. 7B is the RF equivalent circuits for determining the resonant frequency of a loaded single switch slot antenna;

FIG. 8A is a slot antenna with resistive load representing actuated switch (units are in mm);

FIG. 8B is the return loss for different values of switch resistance;

FIG. 8C is the improved return loss withminor adjustments (<4 mm) in the slot length above the feeding point.

FIG. 9A is the reconfigurable slot antenna (units are in mm);

FIG. 9B is the simulated return loss for the four resonant frequencies;

FIG. 9C is the typical radiation pattern;

FIG. 9D is the simulated gain the four resonant frequencies;

FIG. 10 is the measured resonant frequencies of the reconfigurable antenna; and

FIGS. 11A through 11D are the measured radiation patterns for the four resonant frequencies.

### DESCRIPTION OF THE PREFERRED EMBODIMENT

The antenna size at UHF and lower becomes critical and therefore special consideration is required. A compact planar geometry is best suited since three-dimensional large and bulky structures are in general undesirable. Furthermore, some miniaturization techniques have been applied to reduce the size. This section focuses on the passive slot antenna design issues emanating from the above principles.

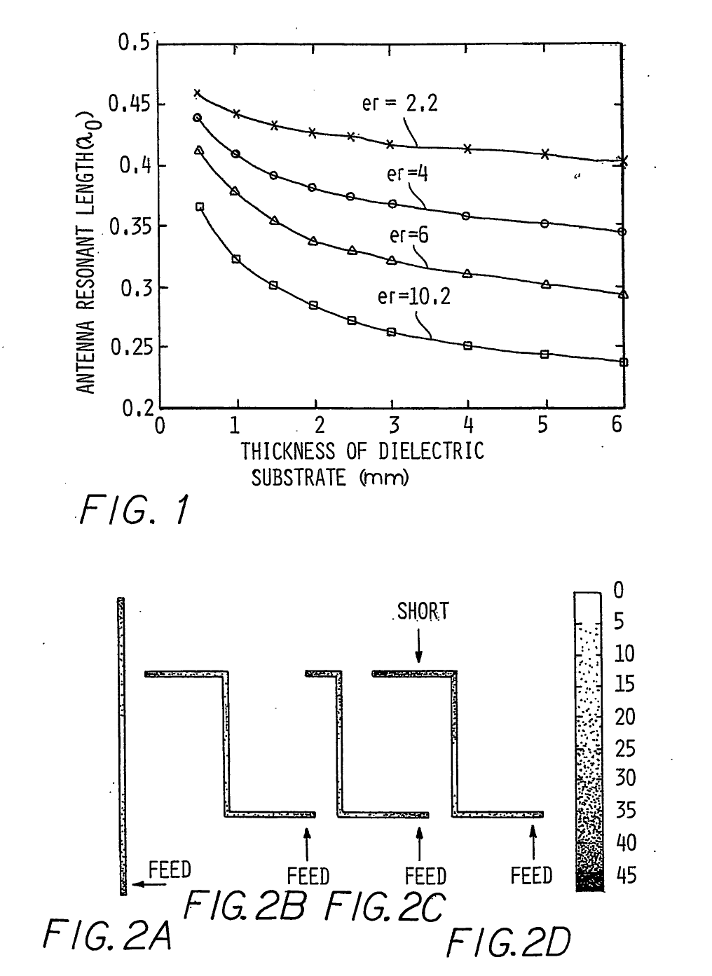

First, the miniaturization capabilities provided by a high dielectric constant substrate were investigated. Inasmuch as an accurate characterization of its effect is needed, a commercially available moment method code was employed. First, simple slot antennas were simulated at 600 MHz and their resonant lengths were determined as a function of the substrate thickness and dielectric constant (FIG. 1). This analysis suggests that even at low frequencies where the substrate is very thin compared to the wavelength, a miniaturization factor of about 2:1 is possible, if a high dielectric constant substrate is employed. However, the standard commercially available substrates are electrically thin at UHF and below and therefore the 2:1 factor seems to be a limit difficult to exceed even for substrate permittivities as high as 10.

In an effort to further decrease the total area occupied by the antenna, the slot configuration was altered from its standard straight form to an S-shape. From the simulated equivalent magnetic current distribution on the straight and S-shape slots (FIGS. 2A and 2B), it is obvious that the distributions both closely follow a sinusoidal pattern with the maximum current concentrated in the middle of the slot. As a result, the two antennas share very similar properties and only differ in the polarization orientation. The antenna of FIG. 2A is horizontally polarized, while the antenna of FIG. 2B slant linearly polarized. Other more complicated geometrical shapes can also be used, but the S-shape slot does not contain any segments supporting opposing currents, which would considerably deteriorate the radiation efficiency. It should also be mentioned that, although the total area of the antenna is greatly reduced by this geometrical change, the resonant length remains almost unchanged. For example, a resonant length of 136 mm for a straight slot is slightly increased to 139 mm for S-slot at 600 MHz for a substrate with e, =10.2 and thickness of 2.54 mm.

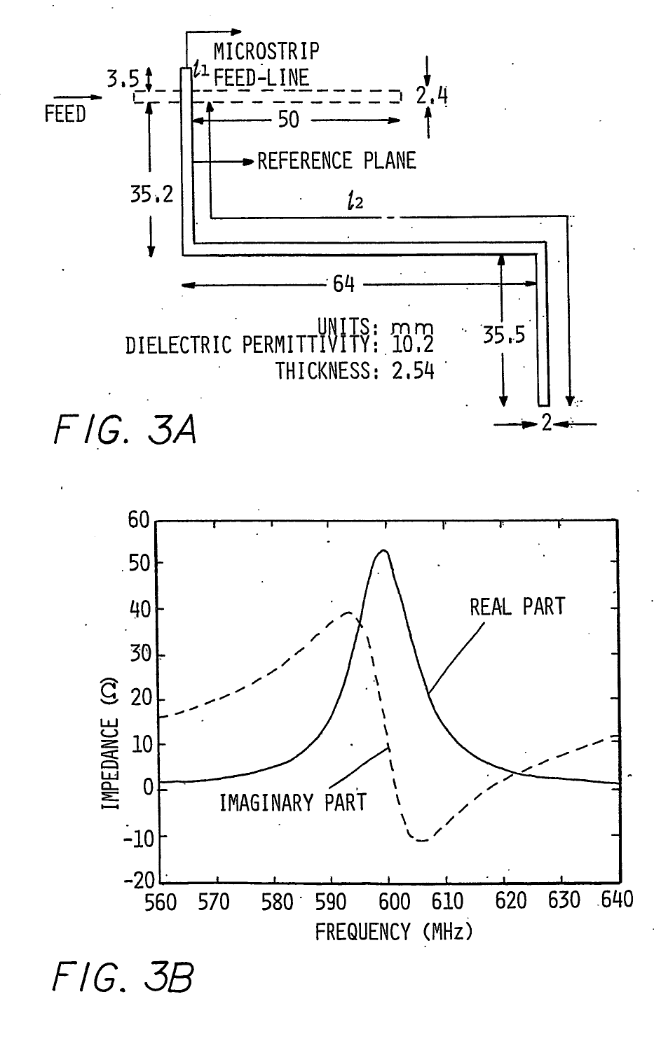

The standard microstrip feed for the simple slot can also be used for the S-shape slot. FIG. 3A shows the slot antenna with its feed-line, while FIG. 3B presents the input impedance at the feeding point as a function of frequency. To achieve a good match to a 50 Ω line, the microstrip feed-line has to be moved close to one end of the slot antenna. This implies that the antenna input impedance is not very sensitive to small changes in the length of the longer segment (12, see FIG. 3A). This property will greatly simplify the design of the tunable slot and its feeding network and will result in minimum complexity and maximum reliability for the final antenna. This property of the slot antenna makes it an attractive choice as a reconfigurable structure, since most other antennas (such as dipoles) would require a specially designed matching network.

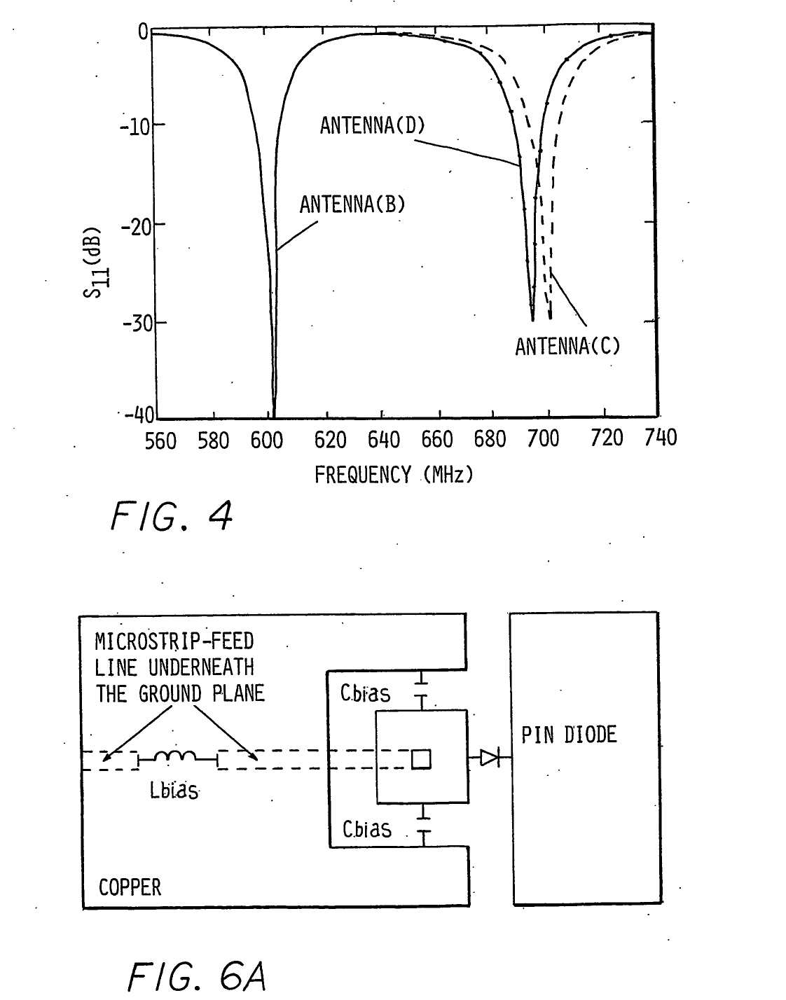

The resonant frequency of the above structure can be tuned by changing the electrical length of the slot. This may be readily accomplished by introducing a short circuit at a specific location. Then the slot will appear to be shorter and therefore the antenna will resonate at a higher frequency. The three S-shape slots in FIG. 2B through 2D demonstrate these concepts. The slot antenna of FIG. 2B resonates at 600 MHz with a resonant length of 139 mm. The antenna of FIG. 2C is 21 mm shorter and is designed to resonate at 700 MHz Finally, the antenna of FIG. 2D is obtained by modifying the antenna of FIG. 2B. In particular, the antenna of FIG. 2B is short circuited at 21 mm above its lower end. The simulated return losses for these three slots are shown in FIG. 4. It is also important to note that the microstrip feed-line remains unchanged in all three cases. That is, the distance between the top end of the slot and the feed line cross point remains constant and is equal to 3.2 mm. This means that, although the resonant frequency is shifted by 100 MHz, very good matching is achieved for both slot antennas illustrated in FIGS. 2C and 2D without the need for modifying the feeding network. In addition, the slot antennas of FIGS. 2C and 2D have almost identical resonant frequencies. The small difference in the resonant frequency comes from the fact that the antenna of FIG. 2D appears somewhat electrically longer than the antenna of FIG. 2C due to the parasitic effects of the short circuit. Therefore, tunability is possible by introducing these short circuits with no special matching network. Although FIG. 2A through 2D illustrates the basic concept of reconfigurability on a dual band antenna, it is obvious that it can be extended to antennas with several bands of operation. The number of these bands depends on the number of switches on the antenna. For example, a four band antenna is presented and it is demonstrated that the resonant frequency can be digitally controlled by an array of four switches.

The basic principle of controlling the antenna resonant frequency has been discussed above. It was also shown that even when a perfect short circuit is used, the parasitic effects of the short can slightly affect the antenna performance and particularly the resonant frequency. The parasitic effects become worse when a switch with finite isolation is used. The issues related to the design of a suitable solid state switch and on the characterization of its effects on the antenna performance will now be discussed. Finally, the complete reconfigurable antenna design is presented below together with its theoretical performance.

A. Switch Design

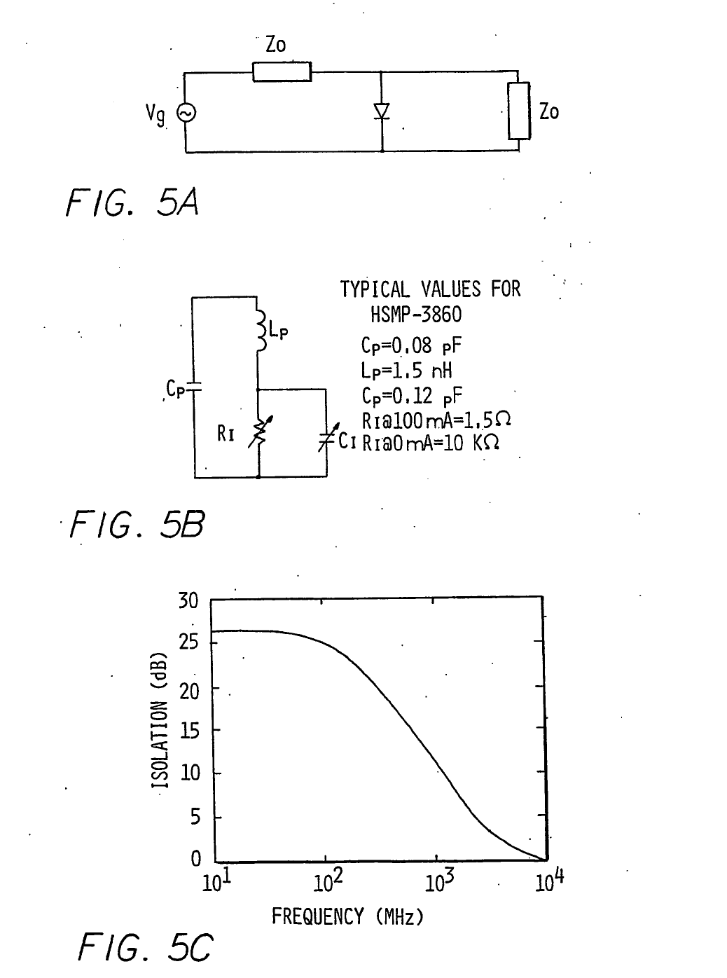

To implement the electronic reconfigurability, the ideal shunt switches must be replaced with PIN diodes. PIN diode's reliability, compact size, high switching speed, small resistance and capacitance in the on and off state respectively make it most appropriate for the application at hand. The RF equivalent circuit of the diode is shown in FIG. 5B for both the on and off states. The reactive components Cₚ and Lₚ model the packaging effect, while the others come from the electric properties of the diode junction in the on and off positions. Typical values are also given for the HSMP-3860 diode used in the present invention. The computed isolation (defined as 1|S₂₁|²) for the circuit shown in FIG. 5A is given by:

$$α = 10 log [ \frac{{( \frac{{R}_{d} {Z}_{0}}{{R}_{d}^{2} + {X}_{d}^{2}} + 2 )}^{2} + {( \frac{{X}_{d} {Z}_{0}}{{R}_{d}^{2} + {X}_{d}^{2}} )}^{2}}{4} ] \qquad ( 1 )$$

where Z_{d}=R_{d}+jX_{d} is the equivalent impedance of the diode and Z₀ is the characteristic impedance of the line. In the example considered here, the characteristic impedance of the line is approximately equal to 60 Ω, which is calculated by the moment method code for a slotline with a width of 2 mm, a finite ground plane of 60 mm (on both sides of the slot) and a substrate permittivity εᵣ=10.2 (RT/Duroid). The isolation computed in equation (1) is plotted in FIG. 5C as a function of frequency for the HSMP-3860 diode in the 60 Ω slotline. Although isolation greater than 25 dB is possible at low frequencies, it degrades to 17 dB at 600 MHz and only 11 dB at 1 GHz due to the diode parasitic elements. However, as will be shown, this attenuation is sufficient for a successful antenna tuning up to 900 MHz.

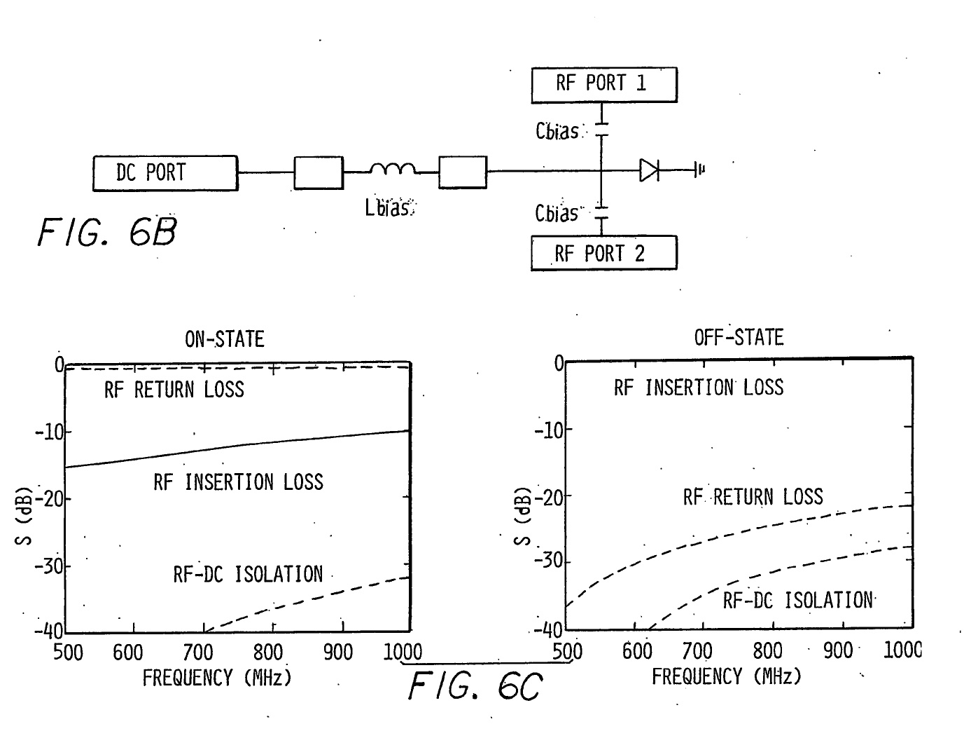

The switch bias network is presented in FIGS. 6A through 6C. An inductor of 470 nH and three 10 pF capacitors are used to improve the RF-DC signal isolation. These values were chosen based on the bias network RF equivalent circuit shown in FIG. 6B. The simulated performance for the on and off states is presented in FIG. 6C. The RF-DC isolation is better than 30 dB for both states and the return loss is less than −20 dB for the off state. Finally, the RF-RF isolation is comparable to the one shown in FIG. 5C.

B. Switch Loading on the Antenna

Although the switch isolation is important since it determines the frequency selectivity of the antenna, the switch loading on the antenna is equally important inasmuch as it affects its resonant frequency and input impedance. The loading effects must be taken into account for an accurate prediction of the antenna resonant frequency and input impedance, especially when more than one switch is used for multi-frequency operation.

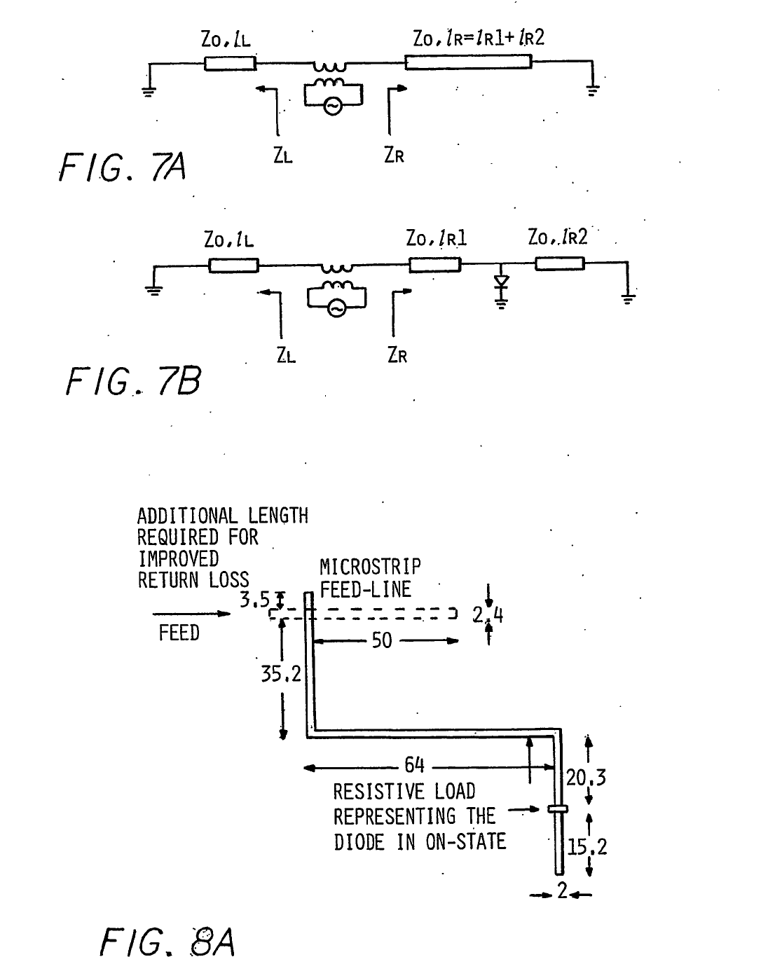

A transmission line equivalent circuit that models the loading effect of one diode on the antenna is shown in FIGS. 7A and 7B. The transverse resonant technique states that:
Z_{R}(z′)+Z_{L}(z′)=0 (2)
where Z_{R}(z′) and Z_{L}(z′) are the input impedances on the right and left of the reference point respectively. For the unloaded transmission line in FIG. 7A equation (2) simplifies to:

$$\begin{matrix}tan ( β {l}_{L} ) + tan ( β {l}_{R} ) = 0 \\ or & ( 3 ) \\ β ( {l}_{L} + {l}_{R} ) = n \frac{π}{2} , n = 1 , 2 , 3 ⋯ & ( 4 )\end{matrix}$$

which is the well known formula for these resonant antennas. Now it is important to see what happens in the simplest case of having one switch on the antenna FIG. 7B shows the equivalent circuit of a transmission line loaded with one switch in the off position. Equation (2) then becomes:
[Z₀ω_{R}C−cot(βl_{R2})][tan(βl_{L})+tan(βl_{R1})]=1+tan(βl_{L})tan(βl_{R1}) (5)
Equation (5) can of course be solved numerically and an iterative method can be employed for finding the unknown lengths until the desired resonant frequency (f_{R}) has been achieved. A similar procedure can be followed if more than one switch is used on the slot, but the process becomes a little more complicated if all resonant frequencies are to be specified. We also need to note that equation (5) does not include any packaging effects, but these can be readily incorporated in the model, resulting in a more accurate computation.

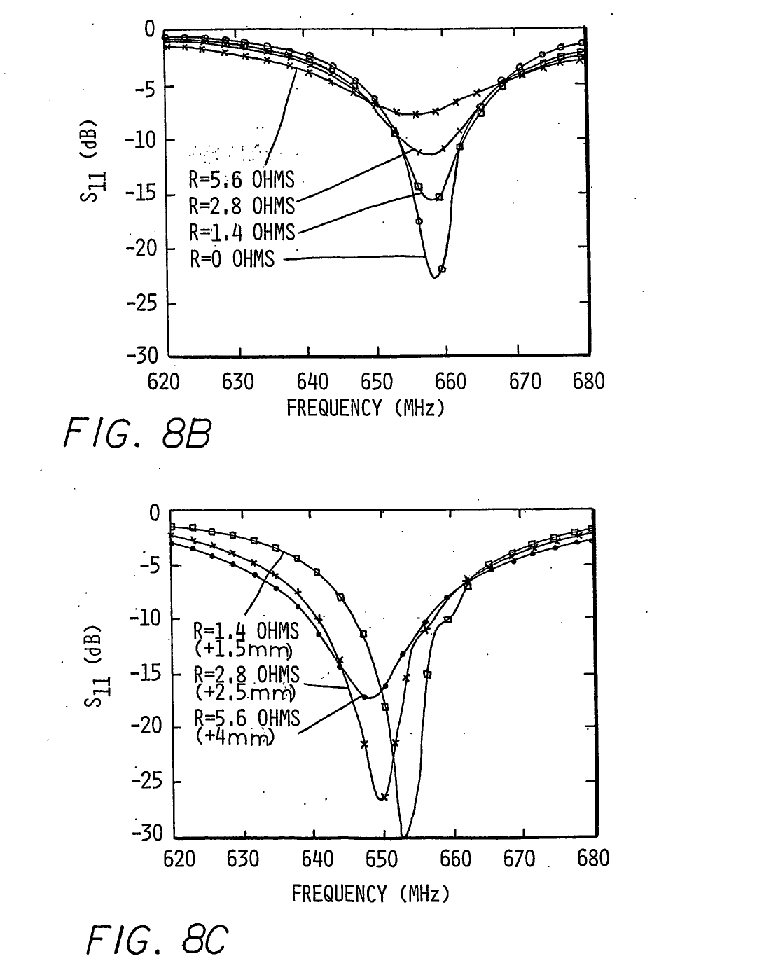

Only the loading effects when the switch is in its off state have been discussed up to now. Nevertheless, the small on-state resistance also affects the antenna performance and particularly its input impedance. Full wave analysis was used to model these effects. For a first order approximation, the resistance was modeled as a thin film resistor on top of the slot and the packaging parasitic elements were neglected in this analysis. The parasitic element effects in the on-state can be important especially at the highest frequencies (see FIG. 5C). FIG. 8A shows the simulated geometry of an S-shape slot antenna loaded with a resistive film, which is fed by a microstrip line and FIG. 8B shows the simulated return loss versus the switch on-state resistance for four different cases between 0 to 5.6 Ω. In all four cases the position of the 50 Ω feed-line was kept unchanged. It is obvious that the matching level deteriorates rapidly as the resistance value increases, and for resistance values above 1.5 Ω the matching level becomes unacceptable.

However, this degradation can be avoided to some extent by elongating the upper end of the slot as the resistance is increased. FIG. 8C shows the improvement on the antenna matching when the slot length is adjusted. It is found that, in all three cases, only a very small line segment length needs to be added in order to improve the input impedance of the antenna. Even for a resistance value of 5.6 Ω the required line segment length is less than 3% of the total slot length, resulting in only a small change in the resonant frequency. This method of maintaining a good impedance match will be used later for the design of the reconfigurable antenna by placing additional switches (matching-switches) on the slot above the feed-line and synchronizing them together with the switches at the other end of the slot (frequency-switches). However, it should be noted that the matching switches will not represent perfect shorts and they will introduce an extra loading effect. Nonetheless, this effect is negligible and matching levels of better than −20 dB can be achieved, as will be seen next. Therefore, the matching properties of the reconfigurable antenna will solely depend on the position of an array of switches on the slot and no matching network will be necessary as frequency changes.

TABLE I
COMPUTED EFFICIENCY FOR SLOT ANTENNAS WITH A
SINGLE SWITCH VERSUS ON-STATE RESISTANCE VALUE

R [Ω]

| | 0 | 1.4 | 2.8 | 5.6 |
|---|---|---|---|---|
| Efficiency [1%] | 71.8 | 55.6 | 45.6 | 33.9 |

Having discussed the loading effects of the switches on the matching properties of the antenna, the effects on the radiation characteristics of the antenna need to be found as well. Ideally, the radiation efficiency should be that of the half-wavelength dipole, since the antenna behaves effectively as a λ/2 resonant slot at each of its operating frequencies. However, the on-state resistance of the switches will obviously result in power dissipation and finally degradation in the antenna efficiency. The dissipated power obviously depends on the diode's on-resistance and on the number of the switches on the antenna. Table I shows the computed efficiency for the antennas previously discussed in FIGS. 8A through 8C. Dielectric loss has been included in all cases. This explains the non-ideal efficiency when R=0 Ω.

The above antenna efficiency analysis shows that even for a small series resistance of R=1.4 Ω the antenna gain will be approximately 2.5 dB lower than that of an ideal halfwavelength dipole. This is an inherent drawback of using PIN diode switches. However, micro-electro-mechanical (MEMS) switches are becoming increasingly important and are now a viable alternative as the MEMS offer very low power consumption and the MEMS come even in smaller packages. It has also been shown that capacitive type MEMS switches exhibit very low ohmic losses and therefore can be used for maximized antenna efficiency. However, the required on-capacitance values renders the capacitive type MEMS impractical for UHF frequencies. Hence metal-to-metal contact switches, which have no cut-off frequency should be considered in such a design.

C. Final Reconfigurable Antenna Properties

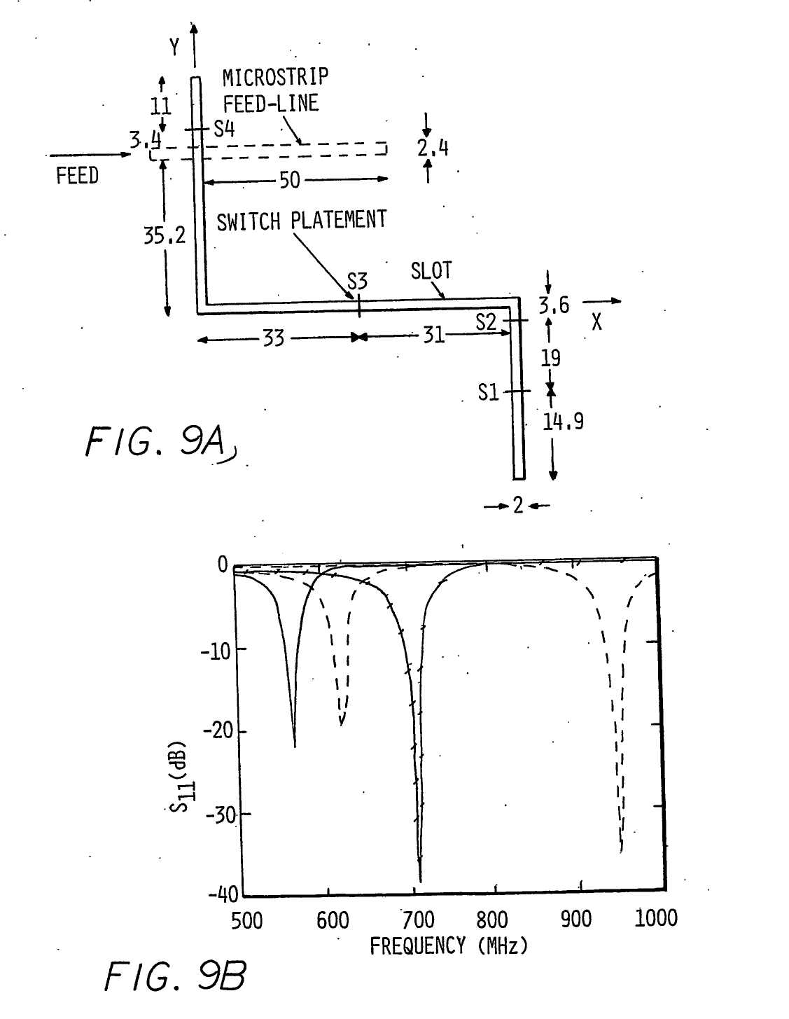

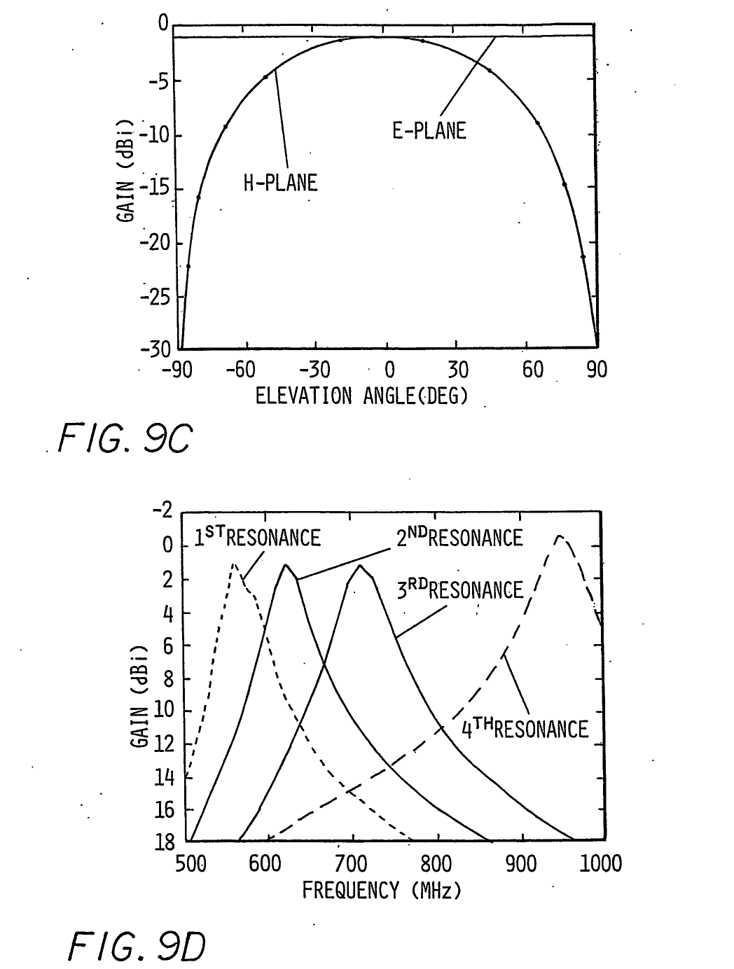

Based on the previously discussed design principles, a reconfigurable slot antenna design (shown in FIG. 9A) is presented here. Four switches are used in order to tune the antenna over a range of 540 to 950 MHz. Both full wave analysis and the transmission line model

TABLE II
THEORETICALLY CALCULATED RESONANT FREQUENCIES
USING FULL WAVE ANALYSIS AND TRANSMISSION LINE
MODEL

| f_{R} [MHz] | f_{R} [MHz] | |
|---|---|---|
| (TLN)^{a} | (MM)^{b} | Switch Configuration |
| 542 | 561 | 4 = ON 1, 2, 3, = OFF |
| 596 | 627 | 1, 4 = ON 2, 3 = OFF |
| 688 | 711 | 2, 4 = ON 1, 3 = OFF |
| 1002 | 950 | 3 = ON 1, 2, 4 = OFF |

^{a}Transmission Line Model
^{b}Moment Method

were used in the design process. In this design three frequency-switches and a single matching-switch are used. Table II summarizes the calculated resonant frequencies and the conditions of all four switches for each resonant frequency. The transmission line model has the advantage of allowing fast and accurate (as will be proven later) computation of the resonant frequencies and can easily incorporate the diode parasitics. However, the full wave analysis is essential when an accurate prediction of the antenna input impedance is needed. In the moment method code, the diodes were simulated as metal-insulator-metal (MIM) capacitors and as thin film resistors in the off and on states respectively and as a result the packaging parasitics were ignored. This explains the 5% differences observed in the computed resonances between the two models. FIG. 9B shows the calculated return loss where a matching level of better than −20 dB has been achieved for all the operating frequencies.

Since at every operating frequency the antenna radiates as a λ/2 slot, the radiation pattern remains unchanged when the frequency is shifted. The same holds for the antenna directivity. The E and H-planes of a typical calculated pattern are shown in FIG. 9C. Since the antenna has been designed on a electrically thin substrate (at UHF) the radiation pattern is symmetric on the two sides of the slot However, the efficiency and the gain will be reduced compared to a half-wavelength dipole due to the resistive losses caused by the

TABLE III
CALCULATED POLARIZATION FOR THE RECONFIGURABLE
ANTENNA

f_{R} [MHz]

| | 561 | 627 | 711 | 950 |
|---|---|---|---|---|
| Angle (°) | 60 | 70 | 60 | 40 |

diodes. FIG. 9D shows the calculated gain using the moment method analysis. The gain is approximately −1 dB for the lowest frequencies and increases to about 0.7 dB for the highest one. Similar results hold for the antenna efficiency.

The reference angle of 0° in the previous graphs represents the direction normal to the antenna ground plane. Although the S-shape pattern considerably reduces the antenna occupied area, it has the inherent drawback that the polarization does not remain constant as the frequency is changed. However, as Table III shows, the polarization does not change considerably (variation of about 30°). This is due to the fact that the antenna polarization (always slant linear) is dominated by the orientation of the middle segment of the slot where most radiated field is emanated from. Therefore, if the orientation of the receiving antenna does not follow that of the transmitter as the frequency is changed, a maximum polarization mismatch of 25% will be incurred. The orientation of linear polarization reported in Table III is with respect to the x-axis (see FIG. 9A).

The reconfigurable antenna designed in the previous section was fabricated on a 100 mil thick RT/Duroid substrate (εᵣ=10.2). The size of the ground plane was 5×5 in².

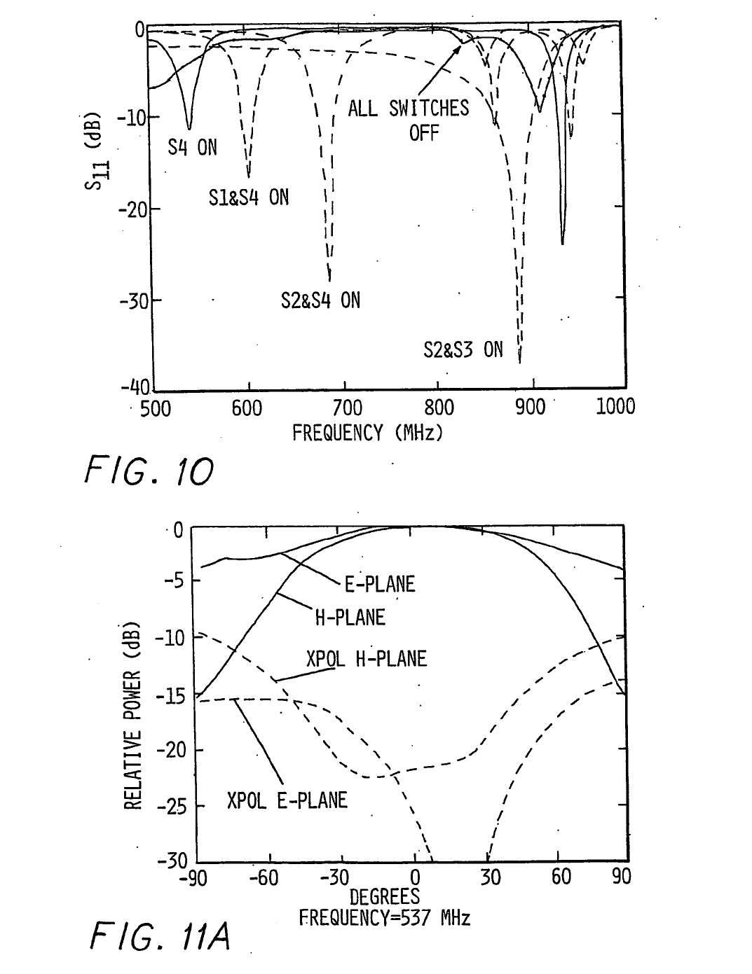

The first task was to measure the resonances and an HP8753D vector network analyzer was used for the S-parameter measurements. The biasing voltage for the switches was provided by a DC voltage source. After calibrating the network analyzer the antenna return loss was measured when different Combinations of the switches were activated. The measured data are presented in FIG. 10, where a return loss of better than −13 dB is observed at all resonances. The measured resonances are shown in Table IV together with the necessary biasing conditions. Satisfactory agreement between theoretical, Table II, and experimental, Table IV, data is observed. In addition, the transmission line model

TABLE IV
MEASURED RESONANT FREQUENCIES AND
THE NECESSARY BIAS VOLTAGES FOR THE SWITCHES

Bias Voltage [V]

| f_{R} [MHz] | S1 | S2 | S3 | S4 |
|---|---|---|---|---|
| 537 | −20 | −20 | −20 | 1.1 |
| 603 | 1.1 | −20 | −20 | 1.1 |
| 684 | 0 | 1.1 | −20 | 1.1 |
| 887 | 0 | 1.1 | 1.1 | 0.2 |

gives slightly better results—except the highest frequency—mainly because the parasitic reactive elements have been included in this model and not in the moment method technique. However, this is not true for the highest resonant frequency where an error of 13% exist between the transmission line model and the measurement. This discrepancy can be attributed to the fact that the properties of the diodes, and particularly the element values of its equivalent circuit, cannot be assumed constant up to 1 GHz.

A reverse voltage of −20 V was applied to maintain the switches in the off position and by doing so a better matching level was achieved. This is an important issue particularly when the antenna is used as the transmitter. Since the structure is a resonant structure strong electric fields are established that can turn the diodes on and off at the RF frequency and ruin the small signal design. This effect was clearly observed at the lowest resonance with an input power of 0 dBm. In this case an improvement of about 5 dB was achieved by changing 0 V bias to −20 V.

One more interesting effect was observed for the highest resonance. Better matching level would occur, if not only S3 but also S2 was forward biased. This is due to the relatively low isolation that each diode provides at these relatively high frequencies (see FIG. 5C). Therefore, biasing S2 results in higher isolation and reduces the effect of leaked magnetic current in the area after the switch The improvement in the return loss was approximately 10 dB compared to leaving S2 unbiased for this frequency.

Next, far field patterns were measured in the University of Michigan's anechoic chamber. The E and H-plane were measured as well as the corresponding cross-polarization for each operating frequency. An RF signal and a DC voltage source were used with the reconfigurable antenna and a dipole with adjustable length was employed as the receiving antenna. The dipole length was appropriately adjusted for each operating frequency of the transmitting antenna until maximum received power was recorded. In order to find the Eplane, the transmitting antenna was rotated until the electric field was vertically polaried. Then the transmitter, placed on a turn table, was azimuthally rotated for measuring Eplane cuts. The cross-polarized pattern was measured by rotating the receiver antenna by 90°. H-plane pattern measurements were conducted in a similar manner.

Although for slot antennas printed on a substrate it is expected that the radiated power be higher in the half-space that include the dielectric substrate, no appreciable difference was observed experimentally. This is easily explained since in this case the dielectric thickness is about λ/200 at 600 MHz and the size of the ground plane is small (approximately λ/3) at the same frequency. Therefore the antenna is almost bi directional and equivalent to a dipole in free space.

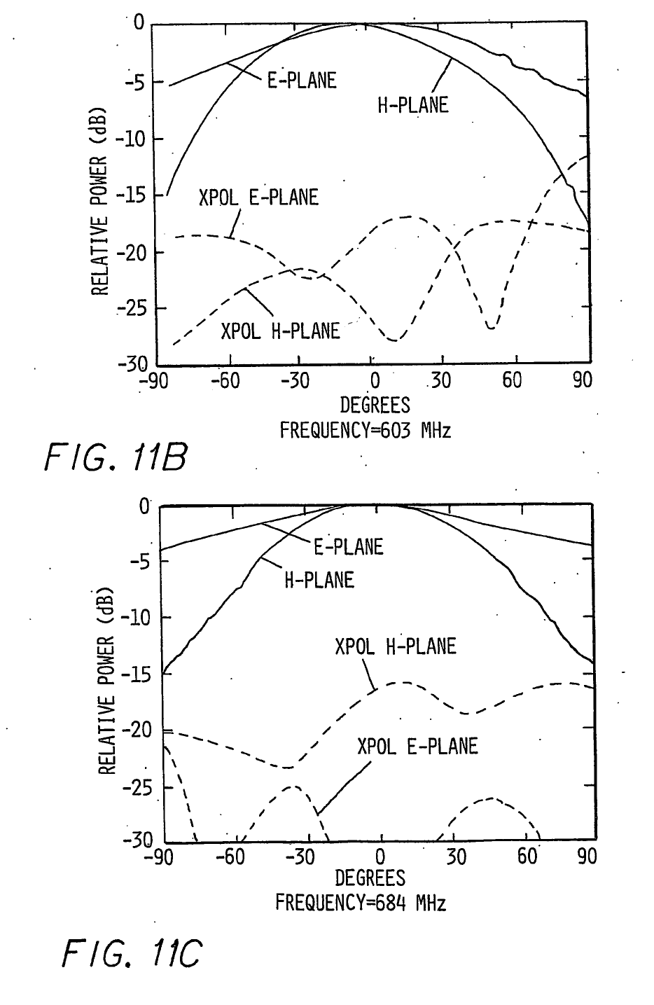

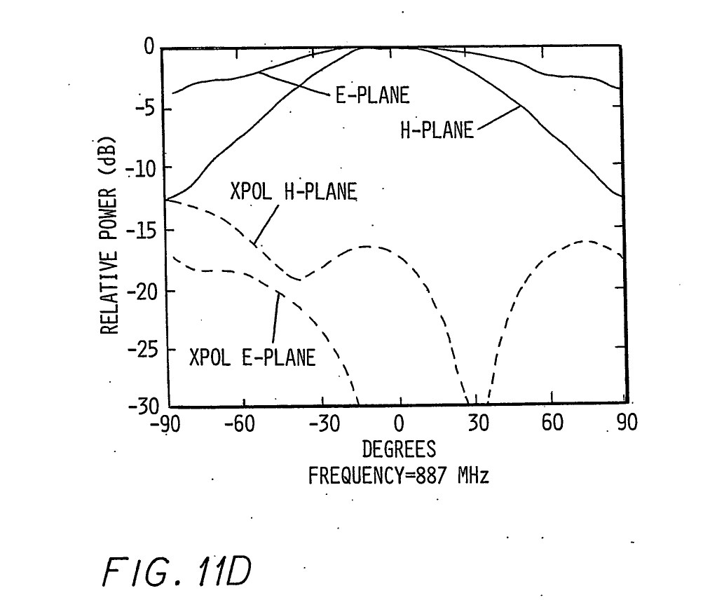

The measured data are presented in FIGS. 11A through 11D for each resonant frequency. In these plots 0° denote the direction of maximum radiated power. These measurements show that the H-plane closely follows the expected sinusoidal pattern. However, some slight asymmetries near ±90° exist for almost all frequencies. These discrepancies originate primarily from two sources. First, parasitic radiation from the cables and the feeding network and second, radiation from the edges of the dielectric. These sources of radiation also affected the Eplane pattern measurements and caused a difference of 3-4 dB between the minimum and maximum measured value. (see FIGS. 11A through 11D). Despite these discrepancies, it is clear that the far-field pattern remains unchanged versus the frequency tuning.

Gain measurements are accomplished using the comparison method. A log-periodic antenna with 6 dBi gain at 600 MHz was used as a reference antenna for these measurements. The second resonance at 593 MHz was chosen as the operating frequency of the reconfigurable antenna, so that to make direct comparisons with the reference antenna possible. To measure the gain, the power received by the receiver dipole at 593 MHz was recorded when both the reference and the reconfigurable antennas were used in the

TABLE V
MEASURED POLARIZATION FOR THE RECONFIGURABLE
ANTENNA

f_{R} [MHz]

| | 537 | 603 | 684 | 887 |
|---|---|---|---|---|
| Angle (°) | 57 | 70 | 55 | 33 |

transmitting mode inside the anechoic chamber under the same conditions. The measured gain was found −1.1 dBi, which corresponds to an efficiency of 47%. These results closely resemble the calculated data It should also be pointed out that the gain of the slot antenna is reduced not only from the forward-biased diode resistance, but also from the small ground plane size. However, a comparison between the measured and calculated data reveals that the dominant degrading factor in gain is the dissipated power on the diodes rather the ground plane size.

Finally, the antenna polarization was measured and the method previously described for the pattern measurement was employed. The measured polarization orientation at each frequency is provided in Table V. As discussed before, although the polarization does not remain absolutely constant as the frequency is changed, the variation range is small and comparable to the theoretical data (see Table III).

A novel method for designing affordable, compact, reconfigurable antennas is proposed in the present invention. This method relies on changing the effective length of a resonant slot antenna by controlling combinations of electronic RF switches. Theoretical results for significant antenna parameters were validated experimentally. Important issues involved in the design of such antennas and guidelines were also discussed. Based on the proposed method, a compact planar reconfigurable slot antenna was designed, fabricated and measured and a tuning range of 1.7:1 in the operating frequency was demonstrated. Although such a broad range was achieved, no matching network was required for the antenna. Another salient feature of this design, backed by theory and experiments, is that the radiation characteristics of this antenna remain essentially unaffected by the frequency tuning. The design procedure is general enough and allows even wider tuning ranges to be achieved. By employing suitable switches it can be also readily extended to higher frequency applications.

While the invention has been described in connection with what is presently considered to be the most practical and preferred embodiment, it is to be understood that the invention is not to be limited to the disclosed embodiments but, on the contrary, is intended to cover various modifications and equivalent arrangements included within the spirit and scope of the appended claims, which scope is to be accorded the broadest interpretation so as to encompass all such modifications and equivalent structures as is permitted under the law.

1. A slot antenna comprising:
a substrate having a single fed resonant slot formed therein; and
a plurality of shunt switches for electrically changing an electrical length of the slot over a wide bandwidth.

2. The slot antenna of claim 1 further comprising:
the slot antenna operating at a plurality of different frequencies over a bandwidth of approximately 1.7:1.

3. The slot antenna of claim 1 wherein the shunt switches further comprises:
a series of PIN diode switches loaded on the slot.

4. The slot antenna of claim 1 wherein the shunt switches further comprises:
a series of micro-electro-mechanical switches loaded on the slot.

5. The slot antenna of claim 1 wherein the shunt switches further comprises:
at least one matching switch loaded on the slot.

6. The slot antenna of claim 1 wherein the shunt switches further comprises:
at least two frequency switches loaded on the slot.

7. The slot antenna of claim 1 wherein the shunt switches further comprise:
at least one PIN diode switch in an off position and being subjected to a reverse voltage to maintain the switch in the off position.

8. The slot antenna of claim 1 further comprising:
the slot formed in the substrate having an S-shape defined by three portions, where two outer portions are angled at approximately 90° with respect to one transversely extending inner portion connecting opposing ends of the outer portions.

9. The slot antenna of claim 8 further comprising:
the plurality of shunt switches forward biasing two of the three portions of the S-shape slot.

10. The slot antenna of claim 9 further comprising:
the two forward biased portions include one of the outer portions and the inner portion of the slot.

11. The slot antenna of claim 1 further comprising:
means for operating at different polarizations for different frequencies within an operating bandwidth of the slot antenna.

12. The slot antenna of claim 1 further comprising:
a very high selectivity over an entire operating bandwidth of the slot antenna allowing operation in reconfigurable wireless networks and anti-jamming systems.

13. The slot antenna of claim 1 further comprising:
means for obtaining a different polarization for every frequency in an operating bandwidth of the slot antenna by appropriately positioning switches on each segment of the slot.

14. A slot antenna comprising:
a substrate having a single fed resonant slot formed therein; and
means for changing an effective length of the resonant slot by controlling combinations of electronic radio frequency switches.

15. A method for designing a slot antenna comprising the steps of:
providing a substrate having a single fed resonant slot formed therein; and
changing an effective length of the resonant slot by controlling combinations of electronic radio frequency switches.

16. The method of claim 15 further comprising the step of:
electrically changing the effective length of the slot over a wide bandwidth with a plurality of shunt switches.

17. The method of claim 15 further comprising the step of:
operating the slot antenna at a plurality of different frequencies over a bandwidth of approximately 1.7:1.

18. The method of claim 15 further comprising the step of:
loading a series of PIN diode switches on the slot.

19. The method of claim 15 further comprising the step of:
loading a series of micro-electro-mechanical switches on the slot.

20. The method of claim 15 further comprising the step of:
loading at least one matching switch on the slot.

21. The method of claim 15 further comprising the step of:
loading at least two frequency switches on the slot.

22. The method of claim 15 further comprising the step of:
subjecting at least one PIN diode switch in an off position to a reverse voltage to maintain the switch in the off position.

23. The method of claim 15 further comprising the step of:
forming the slot in the substrate with an S-shape defined by three portions, where two outer portions are angled at approximately 90° with respect to one transversely extending inner portion connecting opposing ends of the outer portions.

24. The method of claim 23 further comprising the step of:
forward biasing two of the three portions of the S-shape slot.

25. The method of claim 24 further comprising the step of:
selecting the two forward biased portions to include one of the outer portions and the inner portion of the slot.

26. The method of claim 15 further comprising the step of:
operating at different polarizations for different frequencies within an operating bandwidth of the slot antenna.

27. The method of claim 15 further comprising the step of:
providing very high selectivity over an entire operating bandwidth of the slot antenna allowing operation in reconfigurable wireless networks and anti-jamming systems.

28. The method of claim 15 further comprising the step of:
obtain a different polarization for every frequency in an operating bandwidth of the slot antenna by appropriately positioning switches on each segment of the slot.
